(19) United States
(12) Patent Application Publication
(10) Pub. No.: US 2013/0115867 A1
(43) Pub. Date: May 9, 2013

(54) ENCLOSURE SYSTEM AND METHOD FOR APPLYING COATING

(71) Applicants: Krishnamurthy Anand, Bangalore (IN); Yuk-Chiu Lau, Ballston Lake, NY (US); Sundar Amancherla, Bangalore (IN); Eklavya Calla, Bangalore (IN); Viswanathan Venkatachalapathy, Bangalore (IN); James Warren Pemrick, Troy, NY (US)

(72) Inventors: Krishnamurthy Anand, Bangalore (IN); Yuk-Chiu Lau, Ballston Lake, NY (US); Sundar Amancherla, Bangalore (IN); Eklavya Calla, Bangalore (IN); Viswanathan Venkatachalapathy, Bangalore (IN); James Warren Pemrick, Troy, NY (US)

(73) Assignee: General Electric Company

(21) Appl. No.: 13/291,254

(22) Filed: Nov. 8, 2011

(51) Int. Cl. B05B 15/12; B23P 11/00

(52) U.S. Cl. 454/50; 29/428

(57) ABSTRACT

An enclosure system is provided having a shroud configured to cover at least a portion of a shaft. The shroud includes an input port and an output port. The input port is configured to accept at least one of a coating tool and an abrasive supplying tool. The output port is connected to a vacuum system.

### BACKGROUND OF THE INVENTION

The system described herein relates generally to an enclosure system and a method for applying a coating. More specifically, the system relates to an enclosure and method that is used to apply a coating on a rotating shaft of a turbomachine.

Turbine efficiency improvement is an important consideration of any steam turbine value package. Providing the most efficient design while assuring the upgrade or conversion meets or exceeds all performance guarantees and operates reliably is a key objective. When viewing the source of efficiency losses in a steam turbine, about 33% of the total loss can be attributed to leakage. These leakage losses are divided into tip leakage at about 22%, shaft packing at about 7% and root leakage at about 4%. Clearly reducing efficiency loss due to seal leakage can have a significant impact on steam turbine performance.

Brush seals are often used on turbine rotors, and contact between the rotor and the brush leads to frictional heating. Any initial bow in the rotor will lead to a high spot and can lead to a rotor bow due to differential heating. Interstage brush seals and those installed in the shaft ends have an impact on rotor critical speeds. The interstage seals tend to impact the first bending critical whereas the shaft end seals tend to impact the second bending critical. The bristles of the brush seals can also cause undesired wear at any location where they make contact with the rotor. This wear causes increased leakage and reduces overall system efficiency.

### BRIEF DESCRIPTION OF THE INVENTION

In an aspect of the present invention, an enclosure system is provided having a shroud configured to cover at least a portion of a shaft. The shroud includes an input port and an output port. The input port is configured to accept at least one of a coating tool and an abrasive supplying tool. The output port is connected to a vacuum system.

In another aspect of the present invention, a method of providing an enclosure system includes the steps of providing a shroud having an input port and an output port, the shroud configured to cover at least a portion of a shaft, providing at least one of a coating tool and an abrasive supplying tool, placing at least one of the coating tool and the abrasive supplying tool at least partially within the input port, and connecting a vacuum system to the output port.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a perspective partial cut-away illustration of a double flow, low pressure steam turbine;

FIG. 2 illustrates a schematic view of an enclosure system according to an aspect of the present invention;

FIG. 3 illustrates a schematic view of an enclosure system according to an aspect of the present invention;

FIG. 4 illustrates a portion of the shroud and a sealing member, according to an aspect of the present invention;

FIG. 5 illustrates a partial cross-sectional view of a portion of a shroud placed on a shaft, according to an aspect of the present invention; and

FIG. 6 illustrates a perspective view of an enclosure system, according to an aspect of the present invention.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one aspect”, “an aspect”, “one embodiment”, or “an embodiment” of the present invention are not intended to be interpreted as excluding the existence of additional embodiments that also incorporate the recited features.

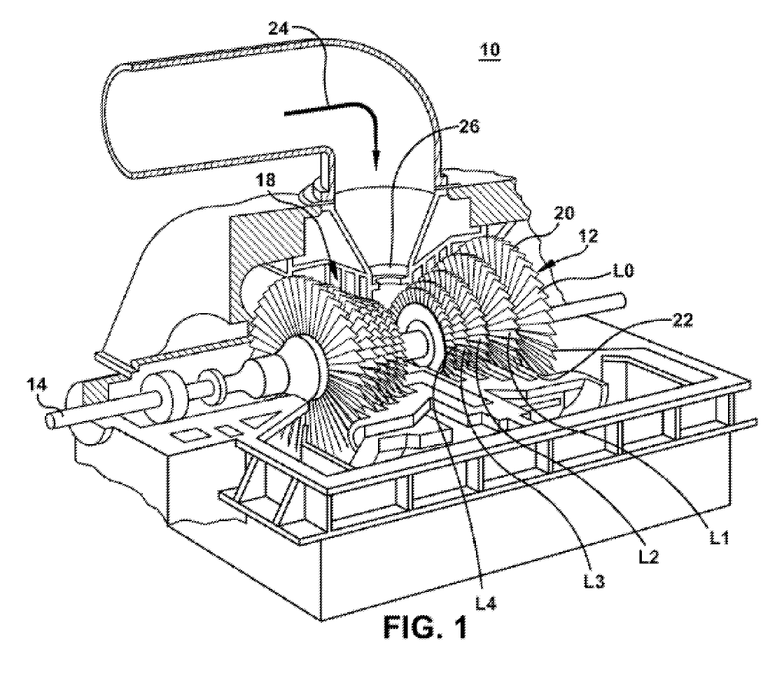

Referring to the drawings, FIG. 1 shows a perspective partial cut-away illustration of a double flow, low pressure steam turbine 10, which is just one example of the type of steam turbine to which the teachings of the invention may be applied. It is to be understood that the teachings of the present invention could be applied to any machine having a rotating shaft, including but not limited to, gas turbines, steam turbines, wind turbines, generators, etc. Steam turbine 10 includes a rotor 12 that includes a rotating shaft 14 and a plurality of axially spaced rotor wheels 18. A plurality of rotating blades 20 are mechanically coupled to each rotor wheel 18. More specifically, blades 20 are arranged in rows that extend circumferentially around each rotor wheel 18. A plurality of stationary vanes 22 extends circumferentially around shaft 14, and the vanes are axially positioned between adjacent rows of blades 20. Stationary vanes 22 cooperate with blades 20 to form a stage and to define a portion of a steam flow path through turbine 10.

In operation, steam 24 enters an inlet 26 of turbine 10 and is channeled through stationary vanes 22. Note, however, that the steam inlet configurations may vary. Vanes 22 direct steam 24 downstream against blades 20. Steam 24 passes through the remaining stages imparting a force on blades 20 causing shaft 14 to rotate. At least one end of turbine 10 may extend axially away from rotor 12 and may be attached to a load or machinery (not shown) such as, but not limited to, a generator, and/or another turbine.

In one embodiment of the present invention as shown in FIG. 1, turbine 10 comprises five stages. The five stages are referred to as L0, L1, L2, L3 and L4. Stage L4 is the first stage and is the smallest (in a radial direction) of the five stages. Stage L3 is the second stage and is the next stage in an axial direction. Stage L2 is the third stage and is shown in the middle of the five stages. Stage L1 is the fourth and next-to-last stage. Stage LO is the last stage and is the largest (in a radial direction). It is to be understood that five stages are shown as one example only, and each turbine may have more or less than five stages. Also, as will be described herein, the teachings of the invention do not require a multiple stage turbine.

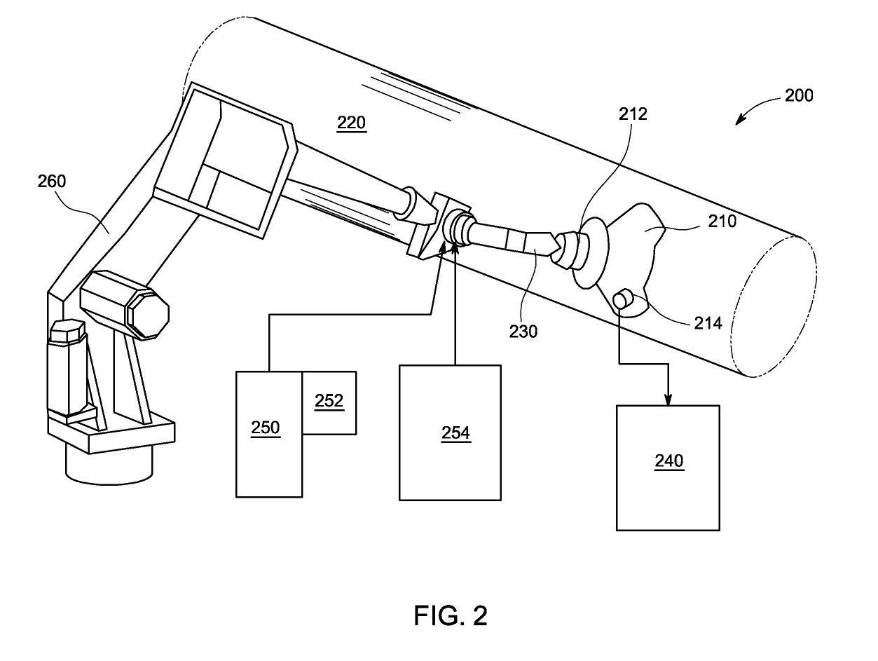

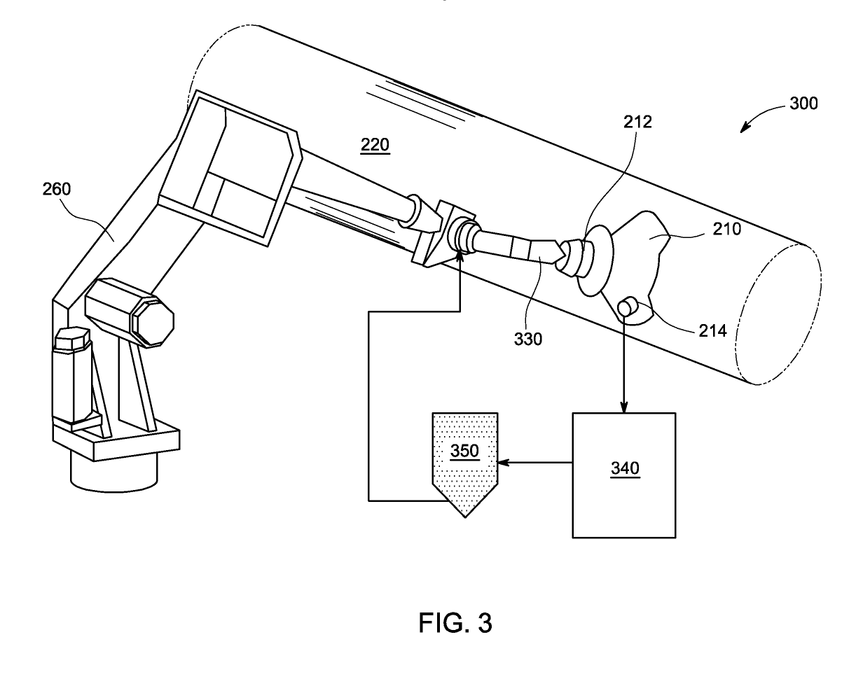

FIG. 2 illustrates a schematic view of an enclosure system according to an aspect of the present invention. The enclosure system 200 includes a shroud 210 configured to cover at least a portion of a shaft 220. The shroud 210 includes at least one input port 212 and at least one output port 214. The input port 212 is configured to accept a coating tool 230 and/or an abrasive supplying tool 330 (see FIG. 3). The output port 214 is connected to a vacuum system 240.

The coating tool 230 may be a high velocity oxygen fuel (HVOF) tool, an air plasma spraying (APS) tool, a low pressure plasma spraying (LPPS) tool, a physical vapor deposition (PVD) tool, an electron beam physical deposition (EBPVD) tool or a cold spray deposition tool. As only one non-limiting example, the coating tool 230 is a high velocity oxygen fuel tool and the high velocity oxygen fuel tool is connected to a fuel supply 250 having control panel 252 and a coating supply 254. The fuel supply 250 could comprise a gas such as hydrogen, methane, propane, propylene, acetylene, natural gas or a liquid such as kerosene, or any other suitable fuel as desired in the specific application. The coating supply 254 could comprise a powder or particulate material comprising ceramics and/or metallic materials, such as but not limited to, WC-Co, chromium carbide, MCrAlY, nickel based alloys or any other suitable coating having the desired wear resistant properties as desired in the specific application.

The coating tool 230 could be used to apply a wear resistant coating to the shaft 220 in likely wear areas, such as near brush seals. The wear resistant coating could be a tungsten-carbide coating, a nickel chromium coating, a chromium carbide coating or any other suitable coating having the desired wear resistant properties as desired in the specific application. As one example only, the wear resistant coating could be applied in a thickness range of about 200-400 microns. Alternatively, a thicker coating of about 8 millimeters to about 12 millimeters may also be used, or any other thickness above or below this range as may be desired in the specific application. In addition, the coating tool 230 may be manipulated by the use of a robotic arm 260 which may be under manual control or controlled by a computer controlled program.

FIG. 3 illustrates a schematic view of an enclosure system according to an aspect of the present invention. The enclosure system 300 includes an abrasive supplying tool 330 connected to an abrasive supply 350. The shroud 210 is configured to cover at least a portion of the shaft 220. The shroud 210 includes at least one input port 212 and at least one output port 214. The input port 212 is configured to accept the abrasive supplying tool 330. The output port 214 is connected to a vacuum system 340. As non-limiting examples only, the abrasive supplying tool 330 is a grit blasting gun or surface preparation gun, and the grit blasting or surface preparation gun is connected to the abrasive supply 350. The abrasive could be any suitable material capable of increasing surface roughness, removing contaminants or removing desired layers, such as but not limited to glass, ceramic or metallic beads or particulate matter, garnet, magnesium sulfate, organic shells (e.g., nut shells, fruit kernels, etc.), silica or sand, corn/wheat starch, sodium bicarbonate (e.g., baking soda), dry ice, water, However, the abrasive supplying tool could be any device capable of removing desired coatings and/or creating a roughened surface on the shaft 220. Other examples of abrasive methods could include vapor honing, glass bead peening, shot peening, waterjet application, and any other suitable method as desired in the specific application.

The vacuum system is connected to the output port 214 and removes abrasive within shroud 210 as well as depositing the abrasive back into abrasive supply 350. Suitable filters (not shown) can be attached to or connected with the vacuum system 340 for removing any undesired contaminants from abrasive supply 350. The abrasive supplying tool draws abrasive from the supply 350 and directs it onto the shaft 220 to increase surface roughness, remove contaminants or remove desired layers. For example, before coating the shaft 220 with a wear resistant layer, certain contaminants (e.g., rust, etc.) can be removed, and the surface roughness of the shaft can be increased (or decreased) to obtain a desirable surface for adherence of the wear resistant coating. As only one example, the surface roughness of portions of the shaft could be manipulated to be about 50 to about 60 microns.

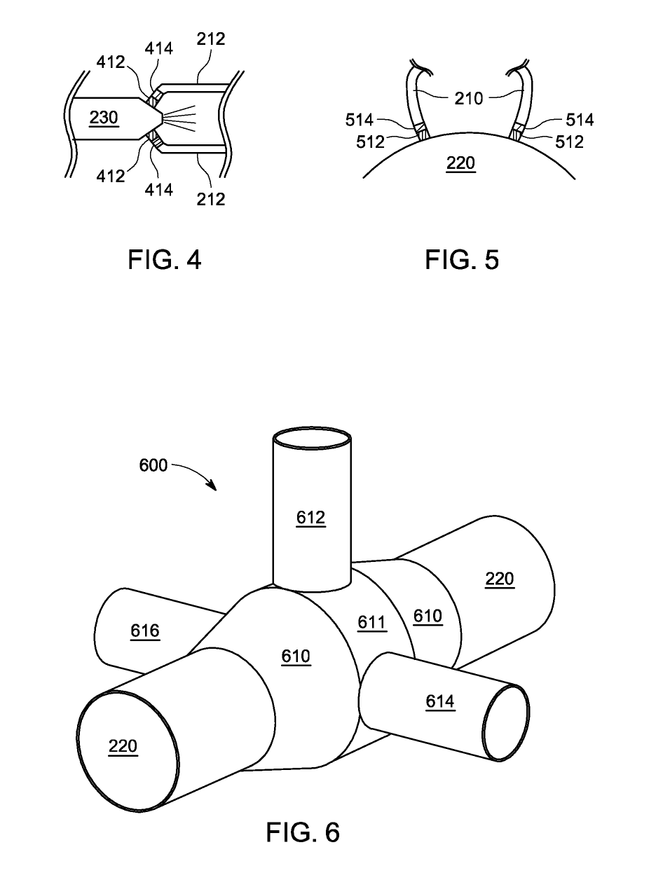

FIG. 4 illustrates a portion of the shroud and a sealing member, according to an aspect of the present invention. The tools 230 or 330, can be inserted a sealing member 410 that is part of input port 212. The sealing member 410 may include an elastomeric sealing member 412 and/or a magnetic sealing member 414. The elastomeric sealing member 412 could take the form of an O-ring and/or be formed of a resilient material that conforms to a portion of the tool 230, 330. The magnetic material 414 may be used to increase attraction force between the sealing member 410 and the tool 230, 330 to improve the sealing characteristics of the junction therebetween.

FIG. 5 illustrates a partial cross-sectional view of a portion of the shroud 210 placed on the shaft 220, according to an aspect of the present invention. The shroud 220 includes a sealing member that may include an elastomeric sealing member 512 and/or a magnetic sealing member 514. The elastomeric sealing member 512 could take the form of an O-ring and/or be formed of a resilient material that conforms to a portion of the shaft 220. The magnetic material 414 may be used to increase attraction force between the shroud 210 and the shaft 220 to improve the sealing characteristics of the junction therebetween, as well as to seal a junction between the shroud and the shaft.

FIG. 6 illustrates a perspective view of an enclosure system 600, according to an aspect of the present invention. A portion of the shaft 220 is enclosed by shroud 610 and collar 611. Both the shroud 610 and collar 611 may be formed of one, two, or three or more pieces. It may be easier to place the enclosure system around shaft 220 when the shroud 610 and collar 611 each are formed of multiple pieces, such as two, or three or more pieces. An input port 612 and an output port 614 are connected to collar 611. If desired additional input ports 616 could also be connected to collar 611. Both the shroud 610 and collar 611 form a shrouded enclosure.

A method of providing an enclosure system is also provided, according to an aspect of the present invention. The method includes the steps of providing a shroud having an input port and an output port, where the shroud is configured to cover at least a portion of a shaft. Another step provides at least one of a coating tool and an abrasive supplying tool. A placing step places at least one of the coating tool and the abrasive supplying tool at least partially within the input port, and a connecting step connects a vacuum system to the output port. A providing step provides a sealing member to seal a junction between the shroud and the shaft, and this step may include providing the sealing member with an elastomeric sealing member, providing the sealing member with a magnetic sealing member, and/or providing the sealing member with both an elastomeric sealing member and a magnetic sealing member. Another providing step provides the input port with an input sealing member.

The step of providing at least one of a coating tool and an abrasive supplying tool may include providing a coating tool that is at least one of a high velocity oxygen fuel (HVOF) tool, an air plasma spraying (APS) tool, a low pressure plasma spraying (LPPS) tool, a physical vapor deposition (PVD) tool and an electron beam physical deposition (EBPVD) tool. In addition, this step may also include providing the high velocity oxygen fuel tool and connecting the high velocity oxygen fuel tool to a fuel supply and a coating supply. Further, the step of providing at least one of a coating tool and an abrasive supplying tool may also include providing an abrasive supplying tool that is a grit blasting gun connected to an abrasive supply.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An enclosure system comprising:
a shroud configured to cover at least a portion of a shaft, the shroud comprising an input port and an output port;
wherein the input port is configured to accept at least one of a coating tool and an abrasive supplying tool, and wherein the output port is connected to a vacuum system.

2. The enclosure system of claim 1, the shroud further comprising a sealing member configured to seal a junction between the shroud and the shaft.

3. The enclosure system of claim 2, the sealing member further comprising an elastomeric sealing member.

4. The enclosure system of claim 2, the sealing member further comprising a magnetic sealing member.

5. The enclosure system of claim 2, the sealing member further comprising an elastomeric sealing member and a magnetic sealing member.

6. The enclosure system of claim 1, the input port further comprising an input sealing member.

7. The enclosure system of claim 6, the input port further comprising at least one of:
an elastomeric sealing member and a magnetic sealing member.

8. The enclosure system of claim 6, the input port further comprising an elastomeric sealing member and a magnetic sealing member.

9. The enclosure system of claim 1, wherein the coating tool is at least one of a high velocity oxygen fuel (HVOF) tool, an air plasma spraying (APS) tool, a low pressure plasma spraying (LPPS) tool, a cold spray deposition tool, a physical vapor deposition (PVD) tool and an electron beam physical deposition (EBPVD) tool.

10. The enclosure system of claim 9, wherein the coating tool is the high velocity oxygen fuel tool and the high velocity oxygen fuel tool is connected to a fuel supply and a coating supply.

11. The enclosure system of claim 1, wherein the abrasive supplying tool is at least one of a grit blasting gun and a surface preparation gun connected to an abrasive supply.

12. A method of providing an enclosure system, the method comprising:
providing a shroud having an input port and an output port, the shroud configured to cover at least a portion of a shaft;
providing at least one of a coating tool and an abrasive supplying tool;
placing at least one of the coating tool and the abrasive supplying tool at least partially within the input port;
connecting a vacuum system to the output port.

13. The method of claim 12, further comprising providing a sealing member to seal a junction between the shroud and the shaft.

14. The method of claim 13, further comprising:
providing the sealing member with an elastomeric sealing member.

15. The method of claim 13, further comprising:
providing the sealing member with a magnetic sealing member.

16. The method of claim 13, further comprising:
providing the sealing member with both an elastomeric sealing member and a magnetic sealing member.

17. The method of claim 12, further comprising:
providing the input port with an input sealing member.

18. The method of claim 12, the step of providing at least one of a coating tool and an abrasive supplying tool further comprising:
providing a coating tool that is at least one of a high velocity oxygen fuel (HVOF) tool, an air plasma spraying (APS) tool, a low pressure plasma spraying (LPPS) tool, a cold spray deposition tool, a physical vapor deposition (PVD) tool and an electron beam physical deposition (EBPVD) tool.

19. The method of claim 18, further comprising:
providing the high velocity oxygen fuel tool and connecting the high velocity oxygen fuel tool to a fuel supply and a coating supply.

20. The method of claim 12, the step of providing at least one of a coating tool and an abrasive supplying tool further comprising:
providing an abrasive supplying tool that is at least one of a grit blasting gun and a surface preparation gun connected to an abrasive supply.
